(19) United States
(12) Patent Application Publication
(10) Pub. No.: US 2015/0252986 A1
(43) Pub. Date: Sep. 10, 2015

(54) LAMP STRUCTURE

(71) Applicants: CHIH-MING YU, HSINCHU COUNTY 302 (TW); JUI-MING HUA, KAOHSIUNG (TW); JEN-CHIEN WANG, HSINCHU COUNTY 302 (TW)

(72) Inventors: CHIH-MING YU, HSINCHU COUNTY 302 (TW); JUI-MING HUA, KAOHSIUNG (TW); JEN-CHIEN WANG, HSINCHU COUNTY 302 (TW)

(21) Appl. No.: 14/202,165

(22) Filed: Mar. 10, 2014

(51) Int. Cl. F21V 19/00; F21K 99/00; F21V 29/503

(52) U.S. Cl. CPC F21V 19/0025; F21V 29/503; F21K 9/56; F21Y 2103/003

(57) ABSTRACT

A lamp structure according to the present disclosure includes an electrical base, a tube, a cover covering the tube, at least one solid-state light source positioned within the tube, a thermal conductive material filled in the tube, two electrodes electrically connected to the solid-state light source, and two supporting members. The supporting members stand at the electrical base to hang the tube to be positioned within the cover.

### BACKGROUND

1. Technical Field

The disclosure relates to a lamp structure, and more particularly, to a lamp structure with tubed light sources.

2. Description of the Related Art

Referring to FIG. 1, a conventional LED lamp 100 includes an electrical base 110 and at least one LED chip 120 positioned on a surface 112 of the electrical base 110. A cover 130 is located to cover the LED chip 120.

In general, the LED lamp 100 has the advantage of low power consumption and high power efficiency. Therefore, the LED lamp 100 has been used as illumination light sources. However, the above-mentioned LED lamp 100 is not good for decoration in comparison with conventional incandescent lamps.

Accordingly, there exists a need to provide a solution to solve the aforesaid problems.

### SUMMARY

The present disclosure provides a lamp structure with a tube-shaped light source.

In one embodiment, the lamp structure according to the present disclosure includes an electrical base, a tube, a cover covering the tube, at least one solid-state light source positioned within the tube, a thermal conductive material filled in the tube, two electrodes electrically connected to the solid-state light source, and two supporting members. The supporting members stand at the electrical base to hang the tube to be positioned within the cover.

In another embodiment, the lamp structure according to the present disclosure includes an electrical base, a tube, a cover covering the tube, at least one solid-state light source positioned within the tube, a thermal conductive material filled in the tube, two electrodes electrically connecting the solid-state light source to the electric base and a thermal conductive pillar. The thermal conductive pillar stands at the electrical base to carry the tube to be positioned within the cover.

According to the lamp structures of the present disclosure, the light sources are sealed in the tubes to form tube-shaped light sources. Therefore, the lamp structures with the tube-shaped light sources are similar to conventional incandescent lamps in structure. In view of the above, the lamp structures are therefore suitable to be used for decoration.

The foregoing, as well as additional objects, features and advantages of the disclosure will be more readily apparent from the following detailed description, which proceeds with reference to the accompanying drawings.

### BRIEF DESCRIPTION OF THE DRAWINGS

FIG. 1 is a schematic view of a conventional LED lamp.

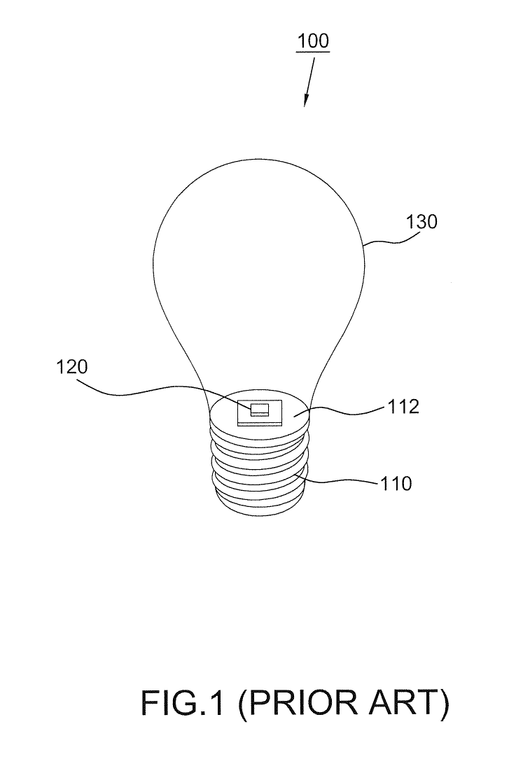

FIG. 2 is a schematic view of the lamp structure according to the first embodiment of the present disclosure.

FIG. 3 is a schematic view of the lamp structure according to the second embodiment of the present disclosure.

### DETAILED DESCRIPTION OF THE PREFERRED EMBODIMENT

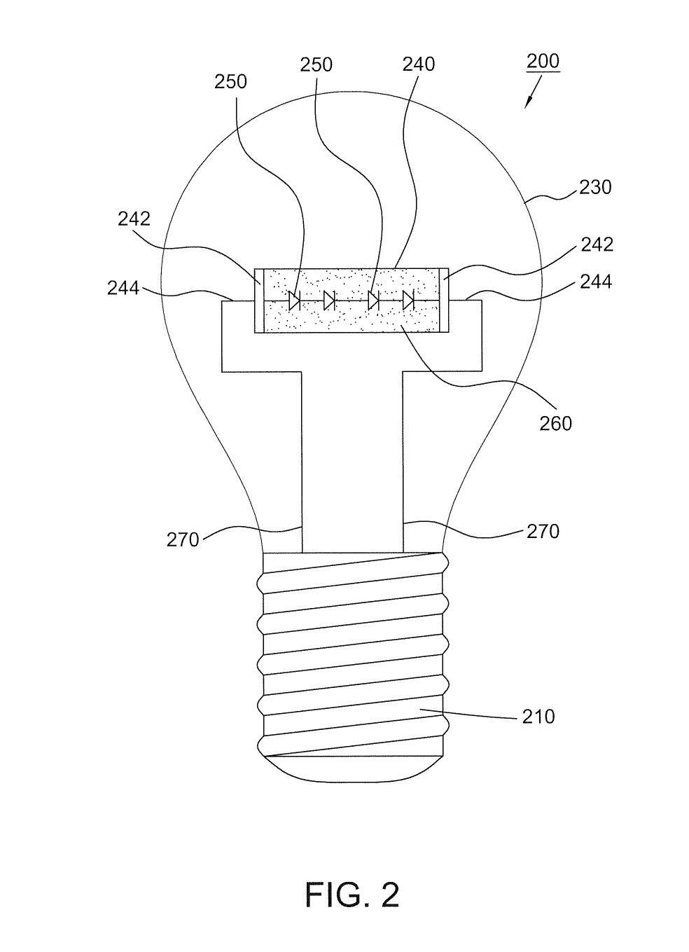

Referring to FIG. 2, the lamp structure 200 according to the first embodiment of the present disclosure includes an electrical base 210, a cover 230 and a tube 240. The tube 240 is positioned within the cover 230. At least one solid-state light source 250, such as light-emitting diode (LED) or organic light-emitting diode (OLED) is located within the tube 240. In one embodiment, the lamp structure 200 may include a plurality of solid-state light sources 250 arranged in series. A thermal conductive material 260 mixed with fluorescent compositions is filled in the tube 240 to enclose the solid-state light source 250. The thermal conductive material 260 may be liquid or solid material. Two electrodes 244 made with metal are electrically connected to the light source 250 and extend out from two open ends of the tube 240, respectively. In order to stop the thermal conductive material 260 from leaving out the tube 240, the open ends of the tube 240 are plugged with two metal blocks 242, respectively. Two supporting members 270 stand at the electrical base 210 and connect with the electrodes 244 respectively to hang the tube 240 within the cover 230. The supporting members 270 may be made with metal and are electrically connected to the light source 250 through the electrodes 244.

According to the present disclosure, the tube 240 may be made from glass or plastic material and be transparent or colored. When the tube 240 is made from plastic material, it may be made from PC or PMMA material.

When the electrical base 210 is plugged into a socket, electricity may be supplied to light up the light source 250 through the supporting members 270 and electrodes 244. The fluorescent compositions mixed in the thermal conductive material 260 may change the wavelengths of the light emitting from the light source 250. The thermal conductive material 260 may help dissipate the heat generated by the light source 250. In addition, the electrodes 244 may also conduct the heat to the electric base 210 so that the heat may dissipate to the ambient air.

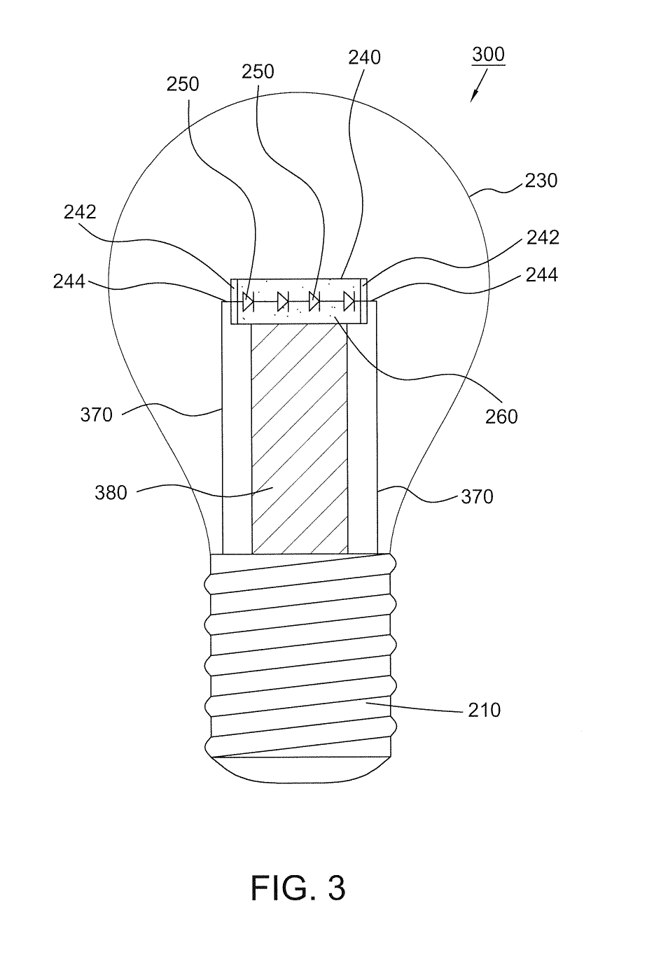

Referring to FIG. 3, the lamp structure 300 according to the second embodiment of the present disclosure has a configuration similar to that of the lamp structure 200, where identical reference numerals have been used when designating substantially identical elements that are common to the figures. The lamp structure 300 similarly includes the electrical base 210, cover 230, tube 240, metal blocks 242, electrodes 244, solid-state light source 250 and thermal conductive material 260. In addition, the lamp structure 300 further has a thermal conductive pillar 380 and two wires 370.

The thermal conductive pillar 380 stands at the electrical base 210 to carry the tube 240 to be positioned within the cover 230. In addition, the thermal conductive pillar 380 may help conduct the heat generated by the light source 250 to the electrical base 210 so that the heat may dissipate to the ambient air. The wires 370 are arranged to electrically connect the electrical base 210 to the electrodes 244, respectively. When the electrical base 210 is plugged into a socket, electricity may be supplied to light up the light source 250 through the wires 370 and electrodes 244.

According to the lamp structures 200, 300 of the present disclosure, the light sources 250 are sealed in the tubes 240 to form tube-shaped light sources. Therefore, the lamp structures 200, 300 with the tube-shaped light sources are similar to conventional incandescent lamps in structure. In view of the above, the lamp structures 200, 300 are therefore suitable to be used for decoration.

Although the preferred embodiments of the disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A lamp structure, comprising:
an electric base:
a tube:
a cover covering the tube;
at least one solid-state light source positioned within the tube;
a thermal conductive material filled in the tube;
two electrodes electrically connected to the solid-state light source; and
two supporting members extending from the electrical base and supporting the tube to be positioned within the cover.

2. The lamp structure as claimed in claim 1, wherein the supporting members are made with metal and are electrically connected to the electrodes, respectively.

3. The lamp structure as claimed in claim 1, wherein the thermal conductive material is mixed with fluorescent compositions.

4. The lamp structure as claimed in claim 1, wherein the solid-state light source comprises a light-emitting diode or organic light-emitting diode.

5. The lamp structure as claimed in claim 1, wherein the thermal conductive material is a liquid material.

6. The lamp structure as claimed in claim 1, wherein the thermal conductive material is a solid material.

7. The lamp structure as claimed in claim 1, wherein the tube is made from glass or plastic material.

8. The lamp structure as claimed in claim 1, wherein the tube is made from PC or PMMA material.

9. The lamp structure as claimed in claim 1, wherein the tube has two open ends, the lamp structure further comprising:
two metal blocks plugged at the open ends of the tube respectively to stop the thermal conductive material from leaving out the tube.

10. The lamp structure as claimed in claim 1, wherein the lamp structure comprises a plurality of solid-state light sources arranged in series.

11. The lamp structure as claimed in claim 1, wherein the thermal conductive material encloses the solid-state light source.

12. A lamp structure, comprising:
an electric base:
a tube:
a cover covering the tube;
at least one solid-state light source positioned within the tube;
a thermal conductive material filled in the tube;
two electrodes electrically connecting the solid-state light source to the electric base; and
a thermal conductive pillar standing at the electrical base to carry the tube to be positioned within the cover.

13. The lamp structure as claimed in claim 12, wherein the thermal conductive material is mixed with fluorescent compositions.

14. The lamp structure as claimed in claim 12, wherein the solid-state light source comprises a light-emitting diode or organic light-emitting diode.

15. The lamp structure as claimed in claim 12, wherein the thermal conductive material is a liquid material.

16. The lamp structure as claimed in claim 12, wherein the tube is made from glass or plastic material.

17. The lamp structure as claimed in claim 12, wherein the tube is made from PC or PMMA material.

18. The lamp structure as claimed in claim 12, wherein the tube has two open ends, the lamp structure further comprising:
two metal blocks plugged at the open ends of the tube respectively to stop the thermal conductive material from leaving out the tube.

19. The lamp structure as claimed in claim 12, wherein the lamp structure comprises a plurality of solid-state light sources arranged in series.

20. The lamp structure as claimed in claim 12, wherein the thermal conductive material encloses the solid-state light source.
